(19) United States
(12) Patent Application Publication
(10) Pub. No.: US 2009/0071342 A1
(43) Pub. Date: Mar. 19, 2009

(54) THERMAL CARAFE ENCLOSURE TO CAPTURE STEAM AND INCREASE COFFEE TEMPERATURE

(76) Inventors: Jamal Hammad, Boynton Beach, FL (US); Zak Hartman, Coral Springs, FL (US)

Correspondence Address: Sunbeam Products, Inc., 2381 Executive Center Drive, Boca Raton, FL, 33431, US

(21) Appl. No.: 11/855,414

(22) Filed: Sep. 14, 2007

(51) Int. Cl. A47J 31/10

(52) U.S. Cl. 99/279

(57) ABSTRACT

A drip coffee maker is provided which include a means for impeding the infiltration of cold air into a gap between a bottom surface of the brew basket housing and the lid of a carafe as the coffee is brewed. The coffee maker includes a base, reservoir housing, and brew basket housing, where a carafe is removably positionable on the base. The carafe including a lid portion, which defines a gap between the lid portion and a bottom surface of the brew basket housing when the carafe is positioned on the base. A means for substantially encircling the gap between the lid portion of the carafe and the bottom surface of the brew basket housing is provided. The means for substantially encircling the gap is operable between an open and a closed position. In the open position, the carafe can be inserted onto the base. As the carafe is inserted, the means for substantially encircling the gap rotates to the closed position. As the carafe is removed from the base, the means for substantially encircling the gap rotates to the open position.

### FIELD OF THE INVENTION

The present disclosure relates to coffee makers, and in particular, to a drip type coffee maker.

### BACKGROUND OF THE INVENTION

In conventional electric drip coffee makers, water is poured into a reservoir and is heated. The heated water is pumped onto coffee grounds in a brew basket to drip into an opening in a top of a carafe. A number of drip coffee makers utilize glass carafes and warming plates. However, significant heat loss through the surface of the glass carafe and contact with cold air as the coffee drips into the opening in the top of the carafe can result in a substantial temperature loss in the brewed coffee.

In some drip coffee makers, the coffee is brewed into a thermal carafe. Exemplary thermal carafes can be made using either a glass vacuum flask or stainless steel vacuum flask. A tightly fitted lid is usually present to prevent cooler air from entering the carafe. However, the coffee still contacts the cold air as the coffee drips into the opening in the top of a carafe, again resulting in a substantial temperature loss.

### SUMMARY OF THE INVENTION

The present disclosure provides a drip coffee maker including a means for impeding the infiltration of cold air into a gap between a bottom surface of the brew basket housing and the lid of a carafe as the coffee is brewed. The coffee maker includes a base, reservoir housing, and brew basket housing, where a carafe is removably positionable under the brew basket housing. The carafe includes a lid portion, which defines a gap between the lid portion and a bottom surface of the brew basket housing.

The means for impeding the infiltration of cold air includes a means for substantially encircling the gap between the lid portion of the carafe and the bottom surface of the brew basket housing. The means for substantially encircling the gap includes a pair of movable arms affixed to the coffee maker, where the movable arms are movable between an open and a closed position. In the open position, the carafe can be inserted between the arms onto the base. As the carafe is inserted, the arms move to the closed position. In the closed position, the arms substantially encircle the gap, blocking the infiltration of cold air. As the carafe is removed from the base, the arms move to the open position.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts an isometric view of a prior art drip type coffee maker;

FIG. 2 depicts a side view of the prior art drip type coffee maker of FIG. 1;

FIG. 3 depicts an isometric view of a coffee maker of the present disclosure;

FIG. 4 depicts a side view of the coffer maker of FIG. 3;

FIG. 5 depicts a pair of movable arms of the coffee maker of FIG. 3 in an open position;

FIG. 6 depicts the pair of movable arms of the coffee maker of FIG. 3 in a closed position;

FIG. 7 depicts a cross sectional side view of the coffer maker of FIG. 3;

FIG. 8 depicts a cross sectional side view of a connection of pair of movable arms to the coffee maker of FIG. 3;

FIG. 9 is a schematic view of a carafe being inserted/removed from the pair of movable arms;

FIG. 10 depicts a schematic representation of a carafe positioned between the pair of movable arms;

FIG. 11 depicts a top view of a range limiter for the pair of movable arms;

FIG. 12 depicts a side view of the connection of pair of movable arms to the coffee maker including a bias member;

FIG. 13 depicts an alternative arm configuration;

FIG. 14 depicts another embodiment of the movable arms; and

FIG. 15 depicts a partial cross-sectional view of the movable arms of FIG. 14 connection to the coffee maker.

### DETAILED DESCRIPTION OF THE INVENTION

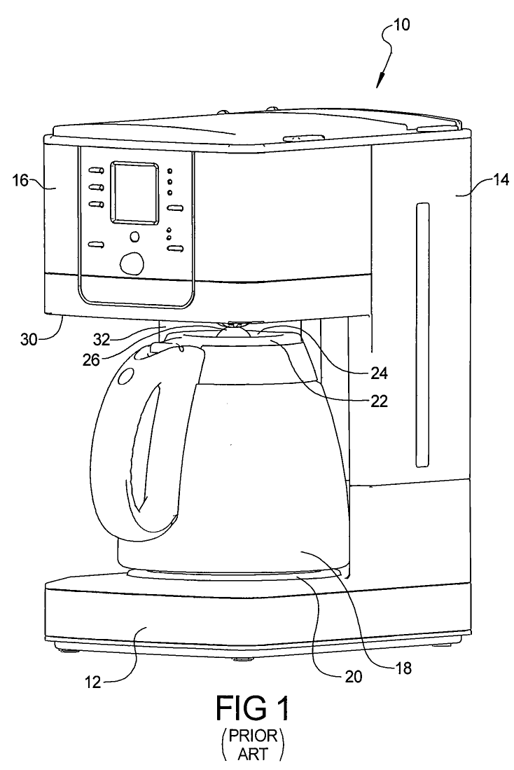

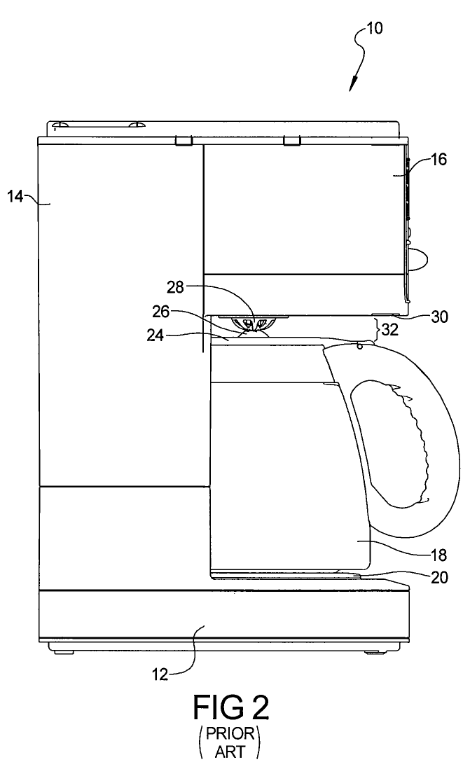

Referring now to the drawing figures in which like reference designators refer to like elements, there is shown in FIGS. 1 and 2 a prior art drip type coffee maker 10. The coffee maker 10 includes a base 12, reservoir housing 14, and brew basket housing 16, where a carafe 18 is positionable on the base 12. The base 12 can include a heating plate 20 for maintaining the temperature of the brewed coffee in the carafe 18.

The carafe 18 includes a carafe lid 16 having an aperture 26 configured for receiving the brewed coffee there through. The carafe 18 is positioned under the brew basket housing 16 such that the carafe lid 24 is proximal to an exit aperture 28 in a bottom surface 30 of the brew basket housing 16. The exit aperture 28 is aligned with the aperture 26 in the carafe lid 24 to supply the brewed coffee into the carafe 18.

As the coffee is brewed, the coffee drips from the exit aperture 28 into and through the aperture 26 into the carafe 18. The exit aperture 28 and the aperture 26 are positioned in a gap 32 between the bottom surface 30 and the carafe lid 24, such that the dripping coffee is exposed to cold air infiltrating the gap 32. The cold air decreases the temperature of the coffee as it drips from the exit aperture 28 into the aperture 26.

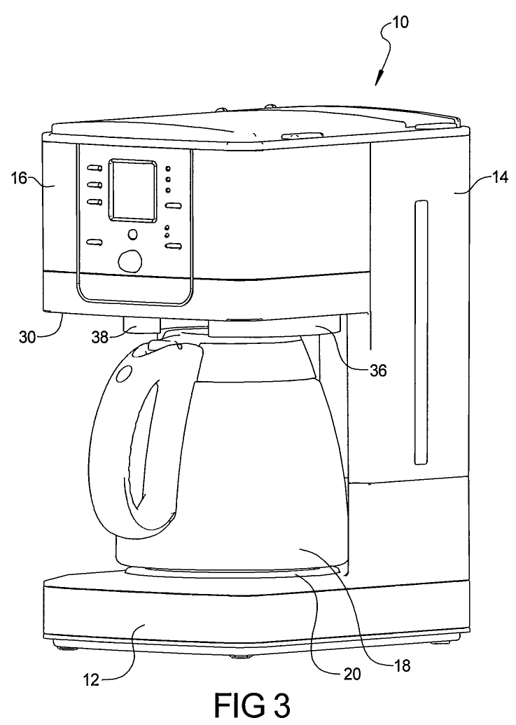

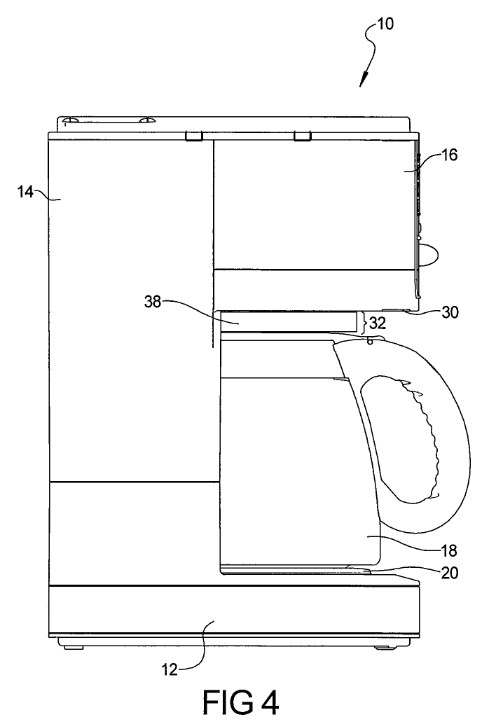

The present disclosure provides a means for impeding the infiltration of cold air into the gap 32 between the bottom surface 30 of the brew basket housing 16 and the carafe lid 24. Referring to FIGS. 3-4, a pair of arms 36, 38 are movably connected to the coffee maker 10. The arms 36, 38 are movable between an open and a closed position. In an open position, the carafe 18 can be inserted between the arms 36, 38. In a closed position, where the carafe 18 is positioned under the brew basket housing 16, the arms 36, 38 substantially encircle the exit aperture 28 and carafe lid 24, providing a barrier to impede the infiltration of the cold air into the gap 32.

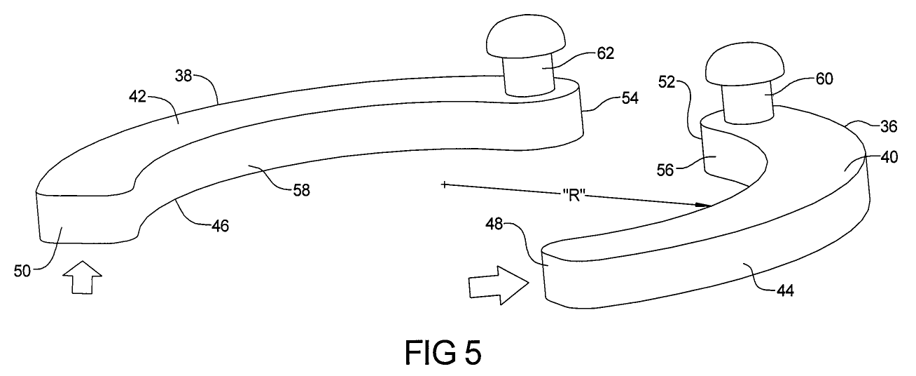

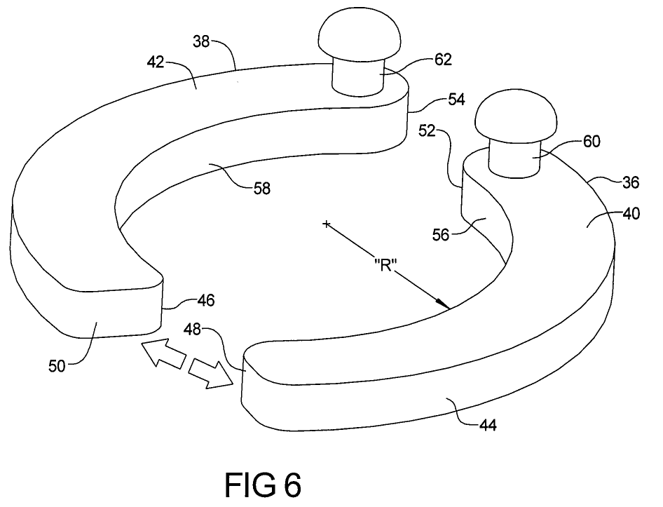

Referring to FIGS. 5 and 6, the arms 36, 38 each include a top surfaces 40, 42, bottom surfaces 44, 46, first end faces 48, 50, second end faces 52, 54. The arms 36, 38 further include an inner arcuate surface having inner radius R. Pivot pins 60, 62 are positioned proximal to the second end faces 52, 54, such that as the arms 36, 38 are actuated between the open and closed positions, the arms 36, 38 move about the pivot pins 60, 62.

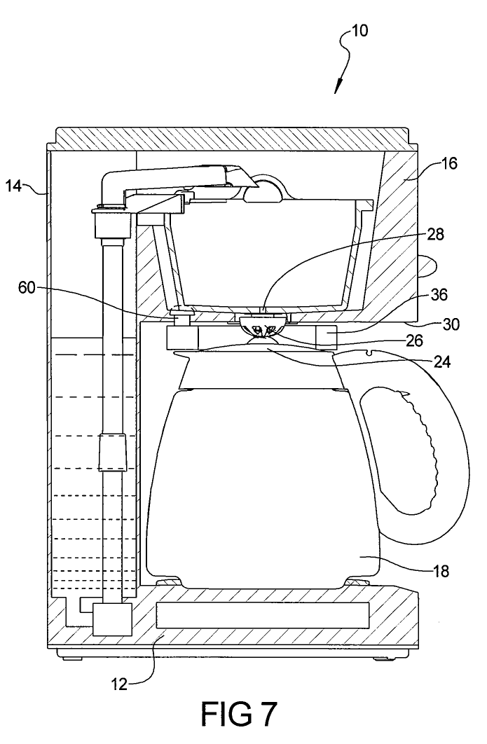

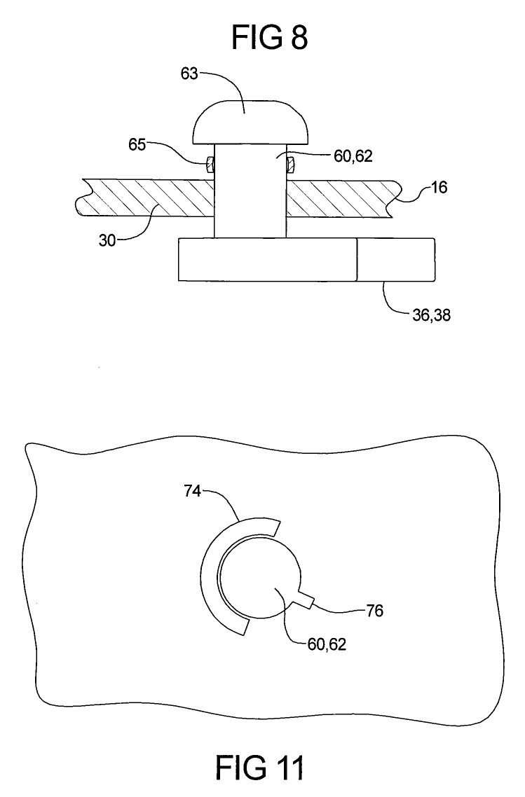

Referring to FIGS. 7-8, the arms 36, 38 are movable connected to the coffee maker 10 by inserting the pivot pins 60, 62 through the bottom surface 30 into the brew basket housing 16. The pivot pins 60, 62 include a securing means 63 for securing the pivot pins 60, 62 to the coffee maker 10. The securing means 63 can be a pin cap, locking ring, or other known devices. A bushing 65 can be positioned on the pivot pin 60, 62, between the locking means 63 and the housing 16 to provide for a smooth rotation of arms 36, 38. The pivot pins 60, 62 secure the arms 36, 38 to the coffee maker 10, such that the top surfaces 40, 42 of the arms 36, 38 are proximal to the bottom surface 30 of the brew basket housing 16.

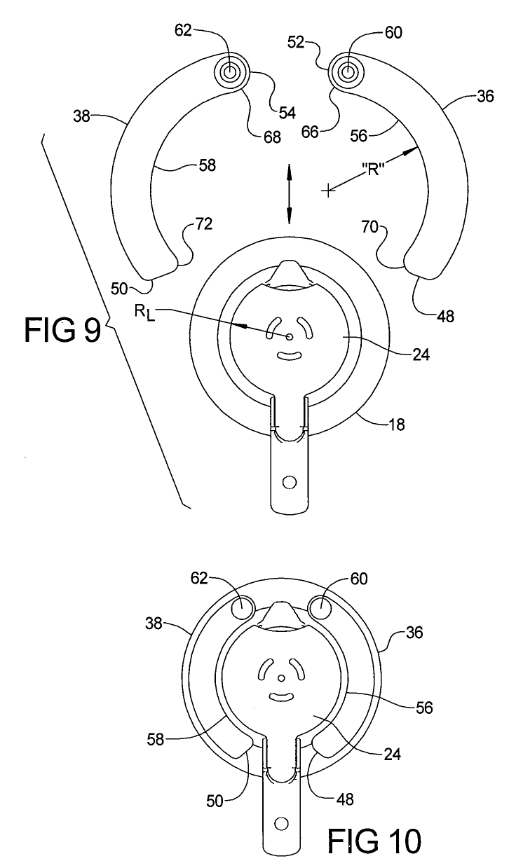

Referring to FIG. 9, in use the arms 36, 38 are initially provided in the open position. The first end faces 48, 50 are of sufficient distance apart to allow for movement of the carafe lid 25 there through. As the carafe 18 is moved under the brew basket housing 16, the carafe lid 24 contacts and provides a force onto the inner contact points 66, 68 on the arms 36, 28. The force rotates the arms 36, 38 about the pivot pins 60, 62. The radius R of the inner surfaces 56, 58 of the arms 36, 38 and position of the pivot pin 60, 62 on the arms 60, 62 are selected to correspond to the radius R_{L} of the carafe lid 24. In this manner, as the carafe 18 is moved under the brew basket housing 16 the arms 36, 38 will move into the closed position substantially encircling the carafe lid 24. (See also FIG. 10).

In the closed position, the first end faces 48, 50 of the arms 36, 38 are in proximal relation each other. Similarly, the second end faces 66, 68 of the arms 36, 38 are in proximal relation each other. In this manner, the inner surfaces 56, 58 of the arms 36, 38 are positioned proximal to the carafe lid 24, substantially encompassing the carafe lid 24.

To remove the carafe 18, the carafe 18 is pulled from under the brew basket housing 16, where the carafe lid 24 contacts and provides a force onto the outer contact points 70, 72 of the arms 36, 38. The force rotates the arm 36, 38 about the pivot pins 60, 62 toward the open position. The radius R and position of the pivot pin 60, 62 is selected to correspond to the radius R_{L} of the carafe lid 24, such that as the carafe 18 is removed from the brew basket housing 16 the arms 36, 38 move into the open position, allowing for an unobstructed removal of the carafe 18.

Referring to FIG. 11, the connection of the arms 36, 38 to the coffee maker 10 can include a means for limiting the range of rotation of the arms 36, 38. The means for limiting the rotation can include a range limiter 74 positioned on the coffee maker 10 and a stop 76 positioned on the pivot pins 60, 62. The range limiter 74 includes first and second ends 78, 80 corresponding to the open and closed positions of the arms 36, 38. As the arms 36, 38 are moved toward the open position, the stop 76 contacts the first end 78 of the range limiter 74 when the arms 36, 38 reach the open position, protecting against an over rotation of the arms 36, 38. Similarly, as the arms 36, 38 are moved toward the closed position, the stop 76 contacts the second end 80 of the range limiter 74 when the arms 36, 38 reach the closed position.

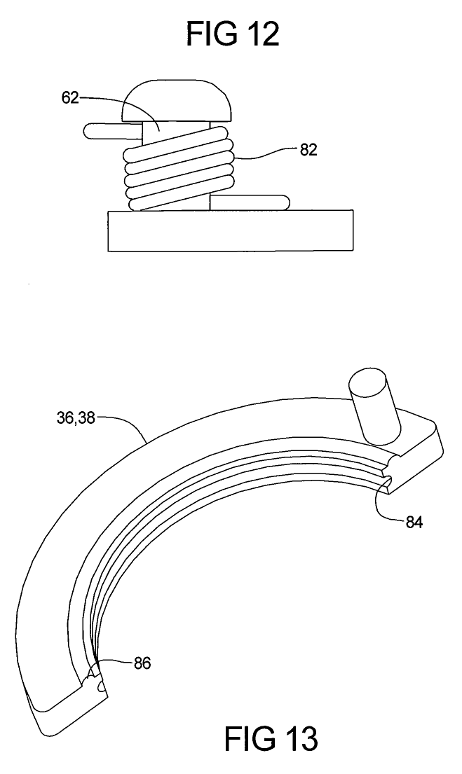

Referring to FIG. 12, the connection of the arms 36, 38 to the coffee maker 10 can include a bias member 82, where the bias member 82 biases the arms 36, 38 into the open position. To close the arms 36, 38, the carafe 18 is moved under the brew basket housing 16 with the carafe lid 24 contacting and providing a force onto the inner contact points 66, 68 of the arms 36, 38. The force rotates the arms 36, 38 about the pivot pins 60, 62 against the force of the bias member 82. The bias member 82 is selected such that the weight of the carafe 18 is sufficient to maintain the arms 36, 38 in the closed position. As the carafe 18 is removed from the base 12, the bias member 82 assists in the opening of the arcuate arms 36, 38, as well as, maintaining the arms 36, 38 in the open position.

Referring to FIG. 13, the arm 36, 38 can include a groove 84 along the inner surface 56, 58 of the arm 36, 38. The groove 84 is configured to engage a lip portion 24 of the carafe lid 24 when the arms 36, 38 are in the closed position.

A raised gasket 86 can be provided on the top surface 40, 42 of the arms 36, 38. The raise gasket 86 is made on a resilient material, such that the raised gasket 86 slides along and provides a seal with the bottom surface 30 of the brew basket housing 16 as the arms 36, 38 are moved between the open and closed positions.

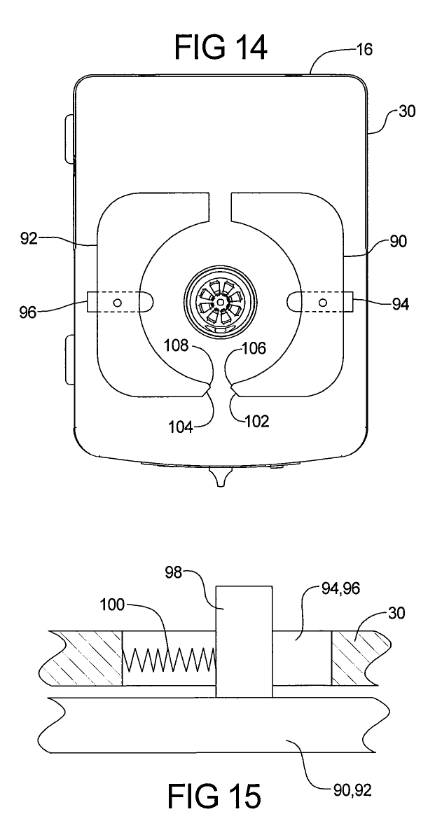

Referring to FIGS. 14 and 15, in another embodiment movable arms 90, 92 are slidably connected to the bottom surface 30 of the brew basket housing 16. The bottom surface 30 include opposing slotted sections 94, 96 into which the pins 98 of arms 90, 92 are slidably positioned. The pins 98 slide within the slotted sections 94, 96 to open and close the arms 98.

The connection of the arms 90, 92 to the coffee maker 10 includes a bias member 100, where the bias member 100 biases the arms 90, 92 into the closed position. To position the carafe 18 under brew basket housing 16, the carafe lid 24 contacts and provides a force onto the outer contact surfaces 102, 104 of the arms 90, 92. The force of the carafe lid 24 against the outer contact surfaces 102, 104 provides a force against the bias member 100 to open the arms 90, 92, where the pins 98 travel within the slotted sections 94, 96 separating the arms 90, 92 about the carafe lid 24. The outer contact surfaces 102, 104 are configures such that they will travel about the outer surface of the carafe lid 24 as the carafe lid 24 is moved between the arms 90, 92. As the carafe lid 24 is positioned under the brew basket housing 16, the bias member 100 closes the arms 90, 92 about the carafe lid 24.

To remove the carafe 18 from under brew basket housing 16, the carafe lid 24 contacts and provides a force onto the inner contact surfaces 106, 108 of the arms 90, 92. The force of the carafe lid 24 against the inner contact surfaces 106, 108 provides a force against the bias member 100 to open the arms 90, 92, where the pins 98 travel within the slotted sections 94, 96 separating the arms 90, 92. The inner contact surfaces 106, 108 are configured such that they will travel about the outer surface of the carafe lid 24 as the carafe lid 24 is moved between the arms 90, 92. As the carafe lid 24 is removed from under the brew basket housing 16, the bias member 100 closes the arms 90, 92.

The slotted sections 94, 96 are depicts as longitudinal sections. However, it is contemplated that the slotted section 95, 96 can be arcuate or angular in shape.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A coffee maker comprising:
a brew basket housing including a bottom surface having an exit aperture;
a pair of arms movable connected to the coffee maker and movable between an open and a closed position; and
a carafe including a lid portion having a lid aperture, the carafe being removably positionable under the brew basket housing with the lid portion being proximal to the bottom surface of the brew basket housing and the lid aperture being aligned with the exit aperture in the brew basket housing when the carafe is positioned under the brew basket housing,
wherein the arms move between the open to the closed positions as the carafe is moved under the brew basket housing to encircle the carafe lid portion.

2. A coffee maker as set forth in claim 1, further comprising a base, wherein the carafe in is positionable the base as the carafe is positioned under the brew basket housing.

3. A coffee maker as set forth in claim 1, wherein the arms move in a horizontal plane.

4. A coffee maker as set forth in claim 1, wherein each of the arms include:
a first end face;
a second end face;
a top surface;
a inner surface; and
a pivot pin affixed to the top surface proximal to the second end face, the pivot pin movably connected to the coffee maker,
wherein the top surface is proximal to the bottom surface of the brew basket housing.

5. A coffee maker as set forth in claim 4, wherein the inner surface is proximal to the lid portion of the carafe in the closed position.

6. A coffee maker as set forth in claim 4, wherein the movable connection of the pivot pin to the coffee maker includes a range of motion limiter.

7. A coffee maker as set forth in claim 4, wherein the pivot pin includes a bias member.

8. A coffee maker as set forth in claim 4, wherein the inner surface includes a groove.

10. A coffee maker as set forth in claim 4, the tope surface including a raised gasket.

11. A drip coffee maker comprising:
a brew basket housing including a bottom surface;
a carafe including a lid portion, the carafe being removably positionable under the brew basket housing and defining a gap between the lid portion and the bottom surface when the carafe is positioned under the brew basket housing; and
a means for substantially encircling the gap between the lid portion and the bottom surface.

12. A drip coffee maker as set forth in claim 11, the bottom surface of the brew basket housing including an exit aperture and the lid portion of the carafe including an lid aperture, wherein the exit aperture is aligned with the lid aperture when the carafe is positioned under the brew basket housing, such that the means for substantially encircling the gap encircles the exit aperture and lid aperture.

13. A drip coffee maker as set forth in claim 11, where in the means for substantially encircling the gap includes a pair of moveable arms.

14. A drip coffee maker as set forth in claim 130, wherein the pair of movable arms are movable between an open and a closed position.

15. A drip coffee maker as set forth in claim 14, wherein the pair of movable arms are moved into the closed position as the carafe is positioned under the brew basket housing.

16. A drip coffee maker as set forth in claim 14, wherein the pair of movable arms are moved into the open position as the carafe is removed from under the brew basket housing.

17. A drip coffee maker as set forth in claim 14, wherein the pair of movable arms each include a bias member.
